(19) United States
(12) Patent Application Publication
(10) Pub. No.: US 2014/0026329 A1
(43) Pub. Date: Jan. 30, 2014

(54) FIREFIGHTER TOOL

(71) Applicant: Terry C. Farrell, Conneaut Lake, PA (US)

(72) Inventor: Terry C. Farrell, Conneaut Lake, PA (US)

(21) Appl. No.: 13/913,607

(22) Filed: Jun. 10, 2013

Related U.S. Application Data
(63) Continuation of application No. 11/857,010, filed on Sep. 18, 2007, now Pat. No. 8,485,074.
Application No. 11/857,010 is a continuation-in-part of application No. 11/493,682, filed on Jul. 26, 2006, now abandoned.

(51) Int. Cl. B25B 7/22

(52) U.S. Cl. CPC B25B 7/22
USPC 7/126

(57) ABSTRACT

A firefighter tool has pivotably connected handles and jaws, and one handle has an outer generally sinusoidal surface and the handle end is formed with a hook facingly disposed to the generally sinusoidal surface. The handles open fully so that the user grips the other handle and the sinusoidal surface hook alternately operably contactingly engages differently sized and configured fire hose couplings.

### PRIOR RELATED APPLICATIONS

This application is a continuation of application Ser. No. 11/857,010, filed Sep. 18, 2007, now U.S. Pat. No. ______, which is a continuation-in-part of application serial no. 11/493,682, tiled Jul. 26, 2006, and claims priority thereto and incorporates the priority applications herein in their entireties by reference thereto.

### BACKGROUND OF THE INVENTION

1. Field of the Invention

This invention relates to hand tools. This invention specifically relates to hand tools having multiple functionalities. This invention more specifically relates to a firefighter tool having multiple functionalities.

2. Background of the Prior Art

Firefighter tools having multiple functions are disclosed in U.S. D210,141, granted Feb. 13, 1968 to Woods; U.S. D226,162, granted Jan. 30, 1973 to Zlayele, Jr., U.S. D233,405, granted Oct. 29, 1974 to Frey; U.S. D244,252, granted May 10, 1997 to Ardis; U.S. D281,216, granted Nov. 5, 1985 to Cutliff, Jr, et al.; U.S. D329,972, granted Oct. 6, 1992 to Calvagno; U.S. Pat. No. 1,561,647, granted Nov. 17, 1925 to Johnson; U.S. Pat. No. 2,360,163, granted Oct. 10, 1944 to Sadler; U.S. Pat. No. 3,599,255 granted Oct. 21, 1968 to Carroll, Sr.; U.S. Pat. No. 3,949,439, granted Apr. 13, 1976 to Ardis; U.S. Pat. No. 4,287,623, granted Sep. 8, 1981 to Tarran; U.S. Pat. No. 4,597,123, granted Jul. 1, 1986 to Cobe, Jr.; U.S. Pat. No. 4,646,378, granted Mar. 3, 1987 to Borden; U.S. Pat. No. 5,105,493, granted Apr. 21, 1992 to Lugtenaar; U.S. Pat. No. 5,428,853, granted Ju. 4, 1995 to Menke; U.S. Pat. No. 6,308,355, granted Oct. 30, 2001 to McMillan et al.; U.S. Pat. No. 6,397,420, granted Jun. 4, 2002 to Roxton; U.S. Pat. No. 6,899,001, granted May 31, 2005 to Sanders et al.; and US Publication 2004/0261188, published Dec. 30, 2004 to Mathis.

The wrench art generally disclosed a unitary member and hook for effectively engaging one specifically sized coupling as disclosed in U.S. D138,515 to Hardy, U.S. D337,492 to Ryan et al. and U.S. Pat. No. 6,705,182 to Bennett.

The firefighter wrench art was directed to a movable or displaceable hook or other movable element in order to engage diversely sized couplings as disclosed in U.S. Pat. No. 6,298,754 to Brown, U.S. Pat. No. 1,936,359 to Huthsing et al. U.S. Pat. No. 5,428,853 to Menke et al., U.S. Pat. No. 5,247,715 to Nishiguchi.

Referring specifically to FIG. 1 (Prior Art), there is shown the multi-purpose rescue tool disclosed in US Publication No. 2006/015674, published Jul. 20, 2006 to Gillingham (“the Gillingham tool”). The Gillingham tool 1 includes a handle 8 with a planar contact surface 2 for engaging small sized fire hose couplings (not shown), wherein there is line contact between the cylindrical surface of the coupling and the handle planar contact surface 2. The Gillingham hook end 3 is curved with a terminal sharp edge which has a limited range of utility the Gillingham tool is only operable with the handles in the closed position. This is because the handles open to only a limited degree, and the arm 4 and cutter 5 disposed in the inside 6 of handle 7 prevent a user from griping the handle 7.

The art desires a firefighter tool that is operable with diversely sized and configured couplings, and wherein a large force may be asserted to readily and effectively rotate and uncouple the diversely sized and configured couplings, particularly where the couplings are seized tight.

The present invention provides a firefighter tool that meets the foregoing art needs.

### SUMMARY OF THE INVENTION

The invention in one principal aspect is a tool member that is a wrench construction having the combination of a generally sinusoidal curvature or surface and a hook disposed at an end of the member and in facing disposition to the generally sinusoidal surface. The combination of the generally sinusoidal surface and the facingly disposed hook permits a user to variously operably engage diversely sized and configured couplings. The present tool engages fire hose couplings of from about 1½″ to 5″ in diameter having from 2 to 6 lugs or ears. The tool member, in one embodiment, may be of one-piece unitary construction.

The invention, in another respect, is a tool that has two members, and each member has a distal end formed with a jaw, and a proximate end formed with one or more grip portions, and a pivot member disposed between the respective ends, so that as pliers the handles open and close the jaws and one member having the afore-discussed combination of the generally sinusoidal curvature or surface and the facingly disposed hook formed at the proximate end of the one member. The user may employ the wrench with the handles opened or closed. The pliers are configured to open so that the fully opened handles subtend an angle of at least about 70°. The user in one mode of operation grips one handle and exerts a large force, through bearing surfaces on the opened jaws, to the wrench end generally sinusoidal surface and to the hook to quickly open seized fire hose couplings.

The sinusoidal curvature or surface includes a convex surface and a contiguous concave surface. The radii of the convex and concave surfaces are about equal. The concave surface is disposed more adjacent to the proximate end of one member than the distal end. The inflection or transition surface disposed between the concave and convex curvatures is generally the contact engagement surface. With the wrench sinusoidal surface engaging each respective coupling cylindrical surface, there is, in contradistinction to a line contact between the coupling cylindrical surface and of the wrench contact surface of the Gillingham tool, an engagement surface area.

The present hook construction extends from the proximate end to the distal end. The hook distal portion or end face has a generally rectilinear construction and a planar angled face. This hook construction provides an operable bearing surface for diversely sized and configured lugs or ears that extend radially outwardly from the coupling cylindrical surface.

The present firefighter tool is diversely operable with diversely sized and configured fire hose couplings. In use, the present firefighter tool exerts a large torque force and readily rotates and uncouples couplings that are seized tight.

### BRIEF DESCRIPTION OF THE DRAWINGS

FIG. 1. is a proximate end perspective view of a PRIOR ART multi-purpose rescue tool;

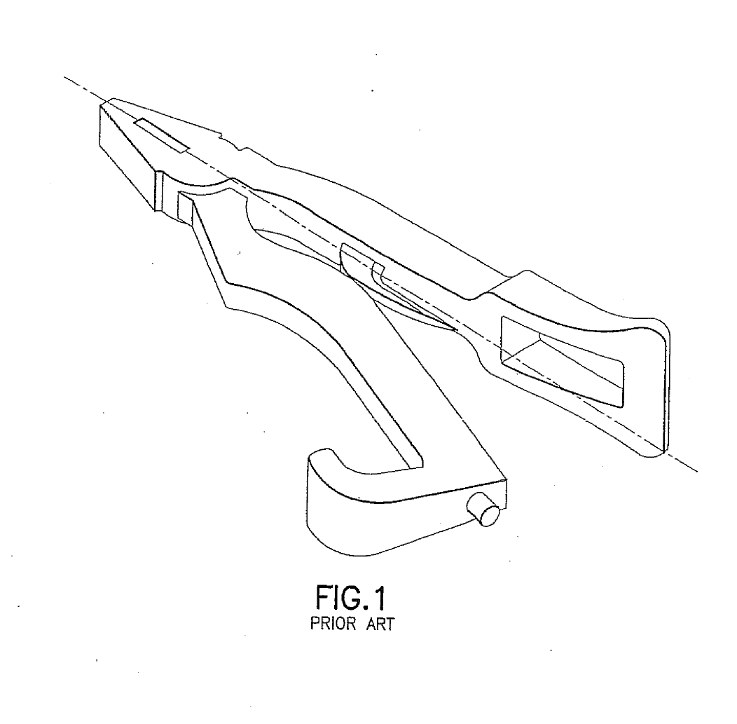

FIG. 2. is a front elevational view of the firefighter tool of the present invention in the fully opened position;

FIG. 3. is a front elevational view of the firefighter tool of FIG. 2 in the fully closed position;

FIG. 4. is a greatly enlarged fragmentary view of the pivot assembly as shown in FIG. 2;

FIG. 5A. is a front elevational view of the firefighter tool of FIG. 2 in use with a fire hose coupling of a first size;

FIG. 5B. is a front elevational view of the firefighter tool of FIG. 2 in use with a fire hose coupling of a second size;

FIG. 5C. is a front elevational view of the firefighter tool of FIG. 2 in use with a fire hose coupling of a third size;

FIG. 6. shows the firefighter tool as in FIG. 5B being operably equipped by the firefighter;

FIG. 7. shows the firefighter tool as in FIG. 3 being operably gripped by the firefighter;

FIG. 8. shows an alternate embodiment of the firefighter tool, alternatively engaging a 3″ coupling with a 5″ coupling; and

FIG. 9. is the firefighter tool of FIG. 2 operably engaging a 3″ reducing coupling of a 5″ coupling.

### DESCRIPTION OF THE INVENTION

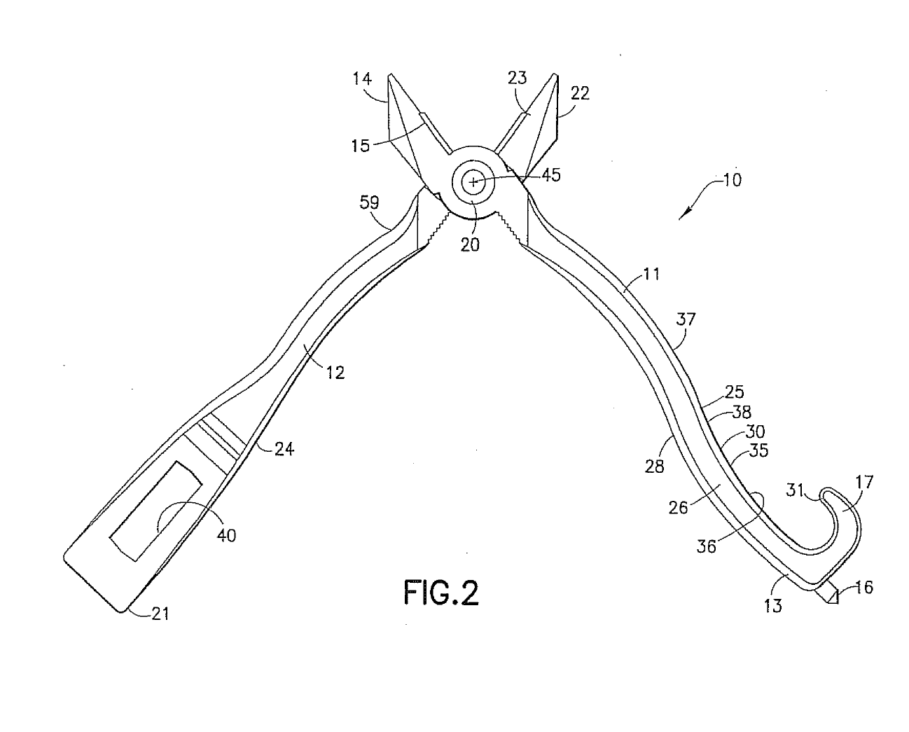

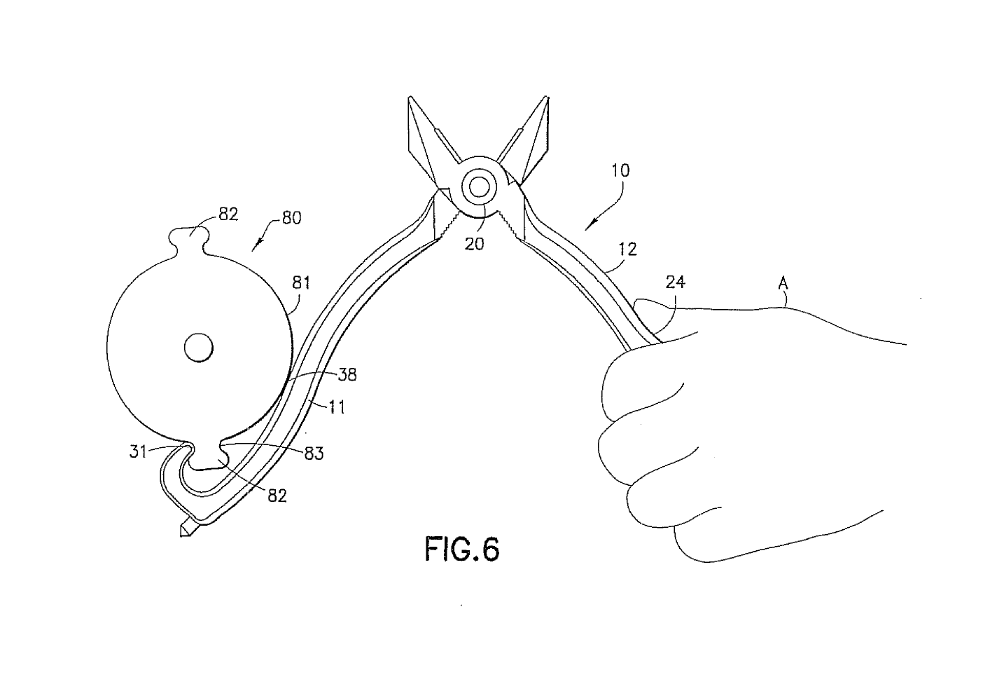

Referring to FIGS. 2-7 and 9, there is shown firefighter tool 10. Tool 10 includes members 11 and 12, pivotally connected by pivot member 20. Member 11 has a proximate end 13 and a distal end 14. Distal end 14 includes jaw 15. Proximate end 13 includes proximately disposed pin 16 and distally extending hook 17, and hook end 31 for purposes hereinafter appearing. Member 12 has a proximate end 21 and a distal end 22. Distal end 22 includes jaw 23. Member 12 includes handle portion 24. Member 11 includes handle portion 25 (see e.g., FIG. 6). Jaws 15 and 23 pivotably open and close with the movement of the handle portions 24 and 25, by pivot member 20.

Handle 25 is formed with a front surface 26, a rear surface 27, an inner surface 28 and an outer surface 30. Outer surface 30 is specifically configured in a generally sinusoidal curvature 35. Surface curvature 35 includes a proximately disposed concave portion 36, a convex portion 37, and an intermediate or transitional portion 38, for purposes hereinafter appearing. The respective radii of curvatures 36 and 37 are about equal. Handle 24 includes a wedge 39 formed at proximate end 21. A through hole wrench 40 is disposed between handle portion 24 and wedge 39. Through hole 40 is a parallel disposition with pivot axis 45 of pivot member 20.

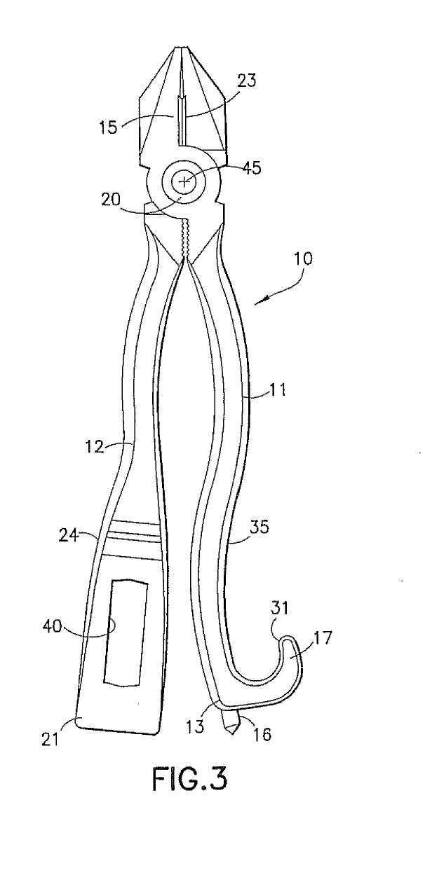

Referring specifically to FIG. 3, there is shown tool 10 in the fully closed position. Jaws 15 and 23 are contactingly engaged. A user (not shown) can grip closed jaws 15 and 23 and use wedge 21 or wrench 40 of member 12. The user (not shown) can otherwise grip closed jaws 15 and 23 and use configured surface 35 in cooperation with hook end 31 for uncoupling a fire hose coupling, as more fully discussed hereinafter.

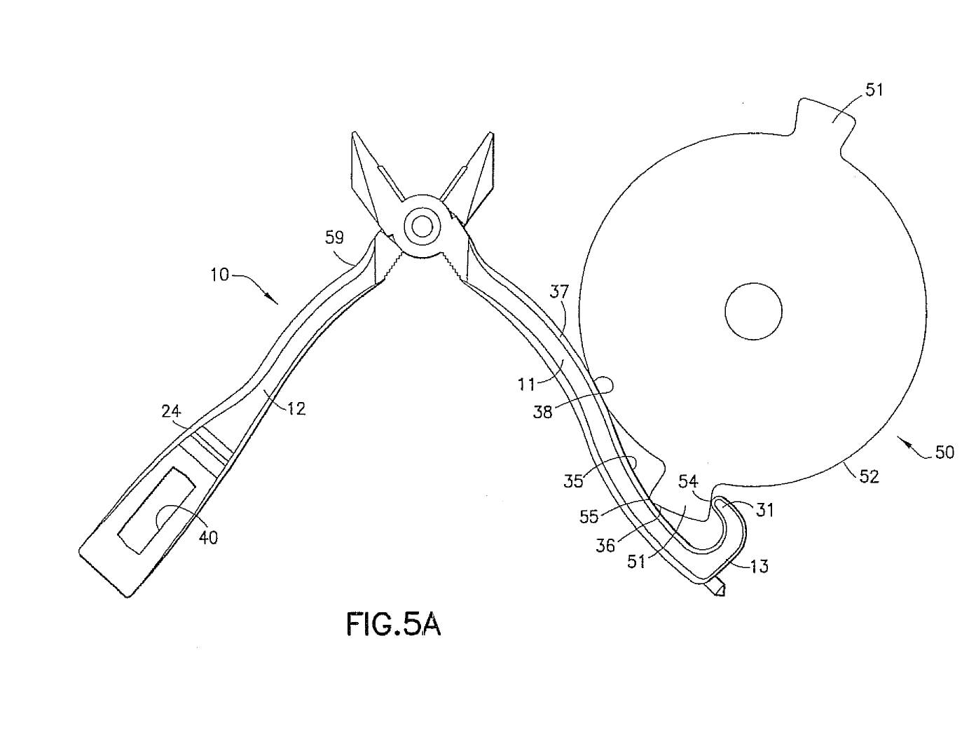

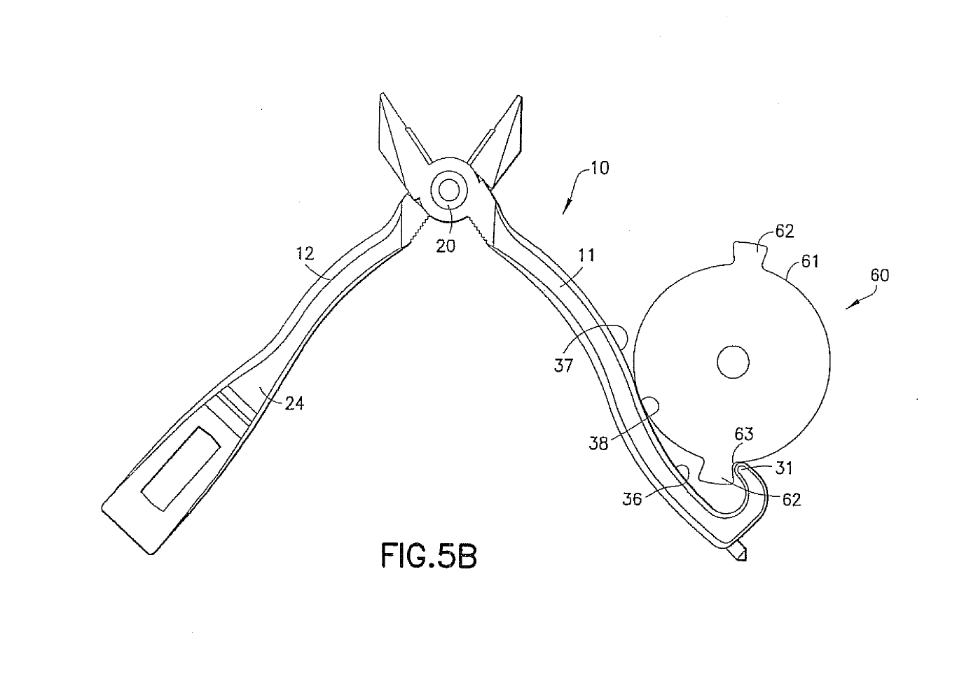

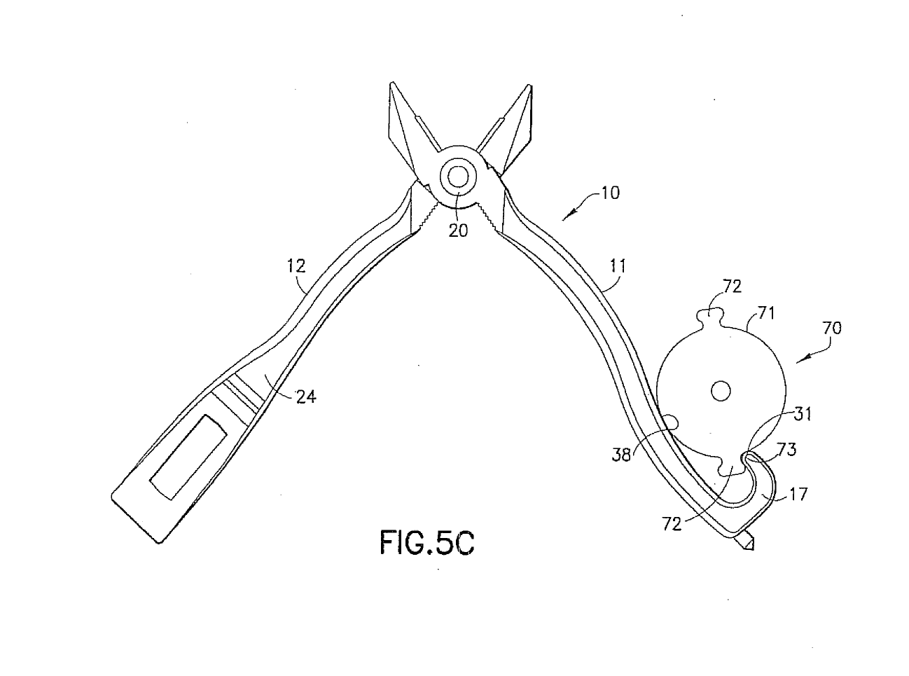

Referring specifically to FIG. 5A there is shown firefighter tool 10 in the fully opened position. Tool 10 is shown in operable engagement with a 5″ fire hose coupling 50. Coupling 50 has 2 radially extending lugs 51 (typical), and cylindrical surface 52. It is understood that fire hose couplings are differently diametrically sized with differently configured and numbered lugs.

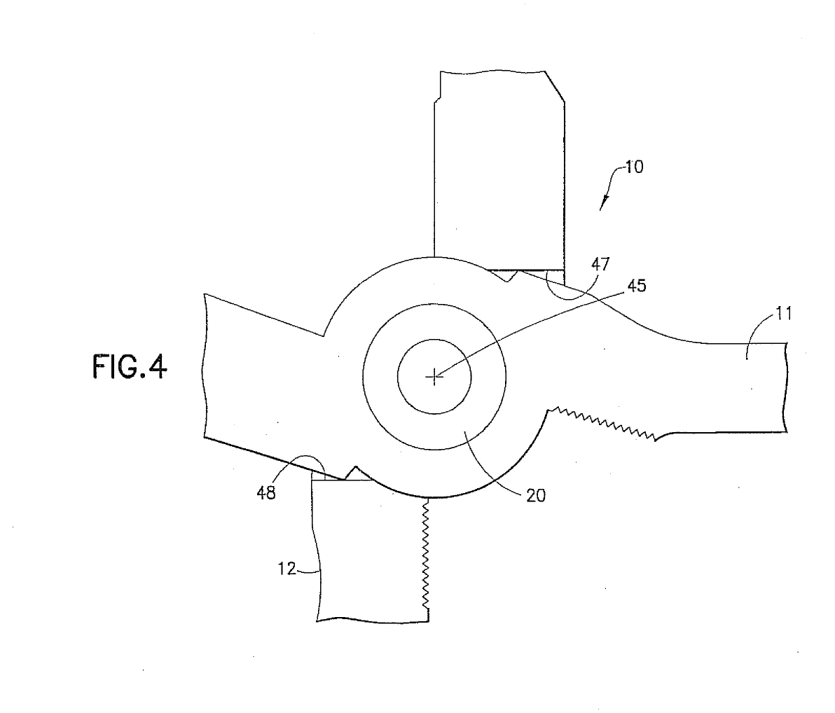

The user (not shown) grips handle 24 of member 12 and causes hook end 31 in combination with facingly opposed surface 35 to engage coupling 50 (FIG. 5A). With respect to the 5″ coupling, hook end 31 engages lug recess 54, concave surface 36 lug engages corner edge 55, and transitional surface 38 engages coupling cylindrical surface 52 (FIG. 5A). The user then exerts an upward force on member 12, which force is transmitted through bearing surfaces 47 and 48 (FIG. 4) to member 11. The exerted force is in turn transferred through surfaces 38 and 36, and hook end 31 to coupling 50 to rotate (counter clockwise as shown in FIG. 5A) to uncouple coupling 50.

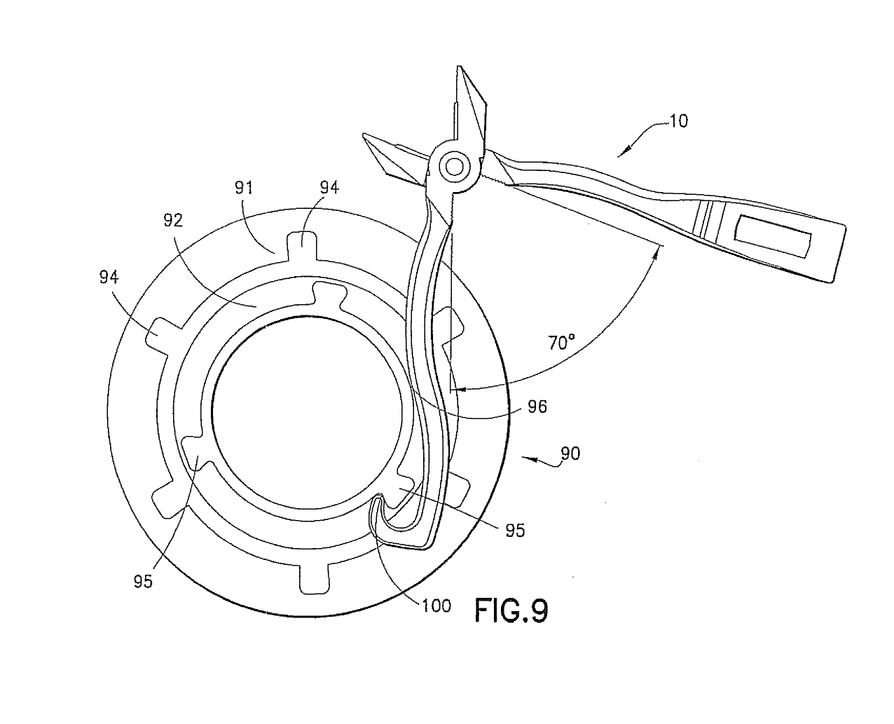

The present construction is designed to cause member 11 and 12 to open to at least about a 70° angle (FIG. 9) when operated in the fully opened mode. This large angular disposition in combination with the force transfer bearing surfaces 47 and 48 cause a substantial torque to be exerted on the coupling. It has been found that when a 250 lb. force is exerted on handle 24 in both the upward and sideward directions a resultant 354 lb. force is generated at 45°. Further, a Von Mises (WCS) stress analysis reveals that the area of highest stress is not in the pivot member 20 area but rather at portion 59 of member 12. The pivot member 20 and bearing surfaces 47 and 48 were found to be surprisingly under low stress. This construction permits an effective torque force to be generated without damage or deformation in and to the pivot member area engaged surfaces.

Referring specifically to FIG. 5B, there is shown tool 10 in operable engagement with 3″ coupling 60. Coupling 60 includes cylindrical surface 61 and lugs 62. Lug 62 (typical) and cylindrical surface 61 converge at recess 63. The user grips handle 24 and causes hook end tip 31 to be inserted in recess 63, with transitional surface 38 contactingly engaged with coupling cylindrical surface 61. The user then exerts an upward force on handle 24 to generate a resultant torque force on coupling 60.

Referring specifically to FIG. 5C, there is shown tool 10 in operable engagement with 1½″-2″ coupling 70. Coupling 70 includes cylindrical surface 71 and lugs 72. Lug 72 (typical) and cylindrical surface 71 converge at recess 73. The user grips handle 24 and causes hook end 31 to fit into recess 73 and transitional surface 38 to contactingly engage cylindrical surface 71. The user then, in a likewise manner, exerts an upward force to generate a resultant torque force on coupling 70.

Referring specifically to FIG. 6, there is shown a reverse side elevational view of tool 10 in operable engagement with 3″ coupling 80. Coupling 80 differs from coupling 70 in that the lugs 82 are differently configured than lugs 72. The user A causes hook tip 31 to be inserted in recess 83 and transitional surface 38 to contactingly engage cylindrical surface 81. A torque force is then exerted in the above-described manner. FIGS. 5A-5C and 6 demonstrate the fully opened mode tool 10 in operable engagement with differently sized and configured fire hose couplings. The present invention provides a universal tool for readily uncoupling diversely sized and configured fire hose couplings.

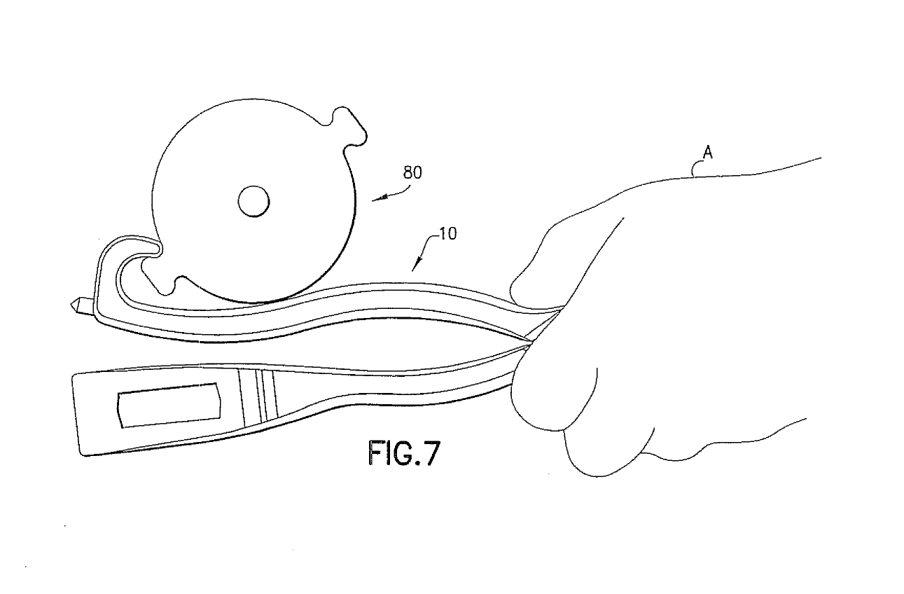

Referring specifically to FIG. 7 there is shown tool 10 in the fully closed mode in operable engagement with coupling 80. The user A grips the surfaces formed by closed jaws 15 and 23, and exerts a downward force to uncouple coupling 80.

Referring specifically to FIG. 9, there is shown tool 10 in the fully opened mode in operable engagement with a standard 5″ to 3″ reduction coupling 90. Reduction coupling 90 is a one-piece unitary forge metal or molded impact resin construction, as is well known in the firefighter tool art. Reduction coupling 90 is formed with a rearwardly disposed 5″ coupling engagement portion 91, and a forwardly disposed 3″ coupling 92. Portion 91 is designed to fit over or cover standard 5″ couplings. The six lug covers 94 engage two or more of the respective 5″ coupling lugs. In this manner of construction, the 5″ coupling is reduced to a 3″ coupling, The resultant 3″ coupling is designed with 3 lugs 95. Tool 10 engages one lug 95 and cylindrical surface 96. The user causes the 3″ coupling and in turn the entire reduction coupling 90 to rotate and in turn uncouple the reduction coupling 90 covered 5″ coupling (not shown).

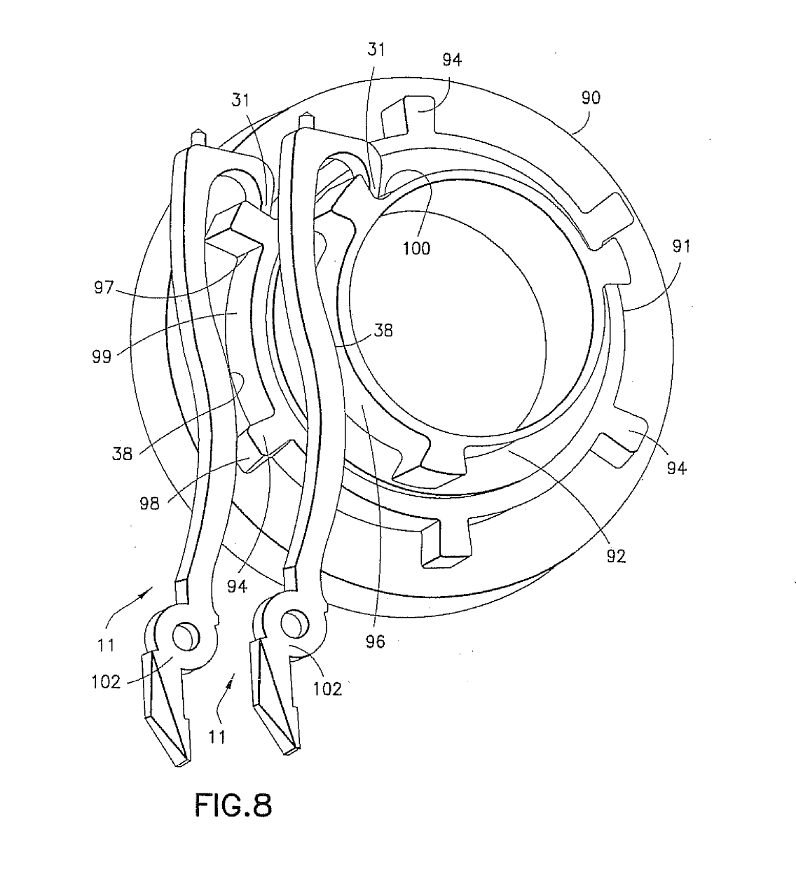

Referring now specifically to FIG. 8, there is shown a second embodiment of the present inventories. In this embodiment, member 11 itself is utilized as a fire hose uncoupling tool. Member 11 is shown in alternate operable engagement of the 5″ coupling portion 91 and the 3″ coupling portion 92. In the 3″ coupling portion 92 engagement, hook tip 31 engages recess formed between lug 94 and cylindrical surface 96 and transitional surface 38 contactingly engages cylindrical surface 96. The user grabs member 11 at the jaw and pivot surfaces 102 and exerts a downward force to cause rotation of reduction coupling 90. In the 5″ coupling portion 91 engagement, hook tip 31 fits into recess 100 and convex surface 37 contactingly engages the outer surface 98 of lug 94. Transitional surface 38 does not contactingly engage and is systematically disjoined from 5″ cylindrical surface 99. FIG. 8 demonstrates the use of one-piece unitary member 11 as a universal uncoupling tool.

It is understood and within the contemplation of the present invention to provide a one-piece unitary forged tool where a forged handle or ergonomic handle may be provided in lieu of the surfaces 102.

The other firefighter elements e.g. wrench 40, wedge 21, pin 16 and jaws 15 and 23 are used in the manner described in application Ser. No. 11/493,682, filed Jul. 26, 2006, published Jan. 31, 2008 as Publ. No. US2008/0022815, which application is incorporated herein in its entirety by references thereto.

While the present invention has been described by reference to a specific embodiment, it should be understood that modifications and variations of the invention might be constructed without departing from the scope of the invention as defined in the appended claims.

1. A firefighter tool comprising;
a first member comprising a proximate end and a distal end, and a proximately disposed first handle comprising a grip and a distally disposed first jaw;
a second member comprising a proximate end and a distal end, and a proximately disposed second handle and a distally disposed second jaw;
means for pivotably connecting the members comprising a pivot axis, and being disposed between the handles and jaws so that the handles pivotably move the jaws from a first operable position to a second operable position;
wherein in said first operable position the jaws and handles are fully closed, and in said second operable position the jaws and handles are fully opened and disposed at an angle; said jaws and handles comprise contactingly engaged force bearing surfaces with the jaws and handles disposed at the said angle and do not open further in said second operable position;
said second handle comprises a hook for engaging a lug of a coupling or cap, said hook being disposed at the proximate end of said second handle, said second handle further comprises a curved surface comprising a first surface being outwardly curved and a second surface being inwardly curved, said second surface being disposed more adjacent the hook than said first surface, said curved surface in combination with the hook for operable contacting engagement with the coupling or cap;
whereby the firefighter alternatively grips the tool in the first operable position and exerts a leverage force on the second handle curved surface or grips the first handle grip and not the second handle in the second operable position and exerts a leverage force on to the second handle curved surface to exert a resultant torque force on the coupling or cap.

2. The firefighter tool of claim 1, wherein the angle is up to 114°.

3. The firefighter tool of claim 1, wherein the second handle comprises a generally sinusoidal surface.

4. The firefighter tool of claim 1, wherein the jaws comprise blade edges.

5. The firefighter tool of claim 1, said first handle grip extends around the first handle and being disposed between the wedge and the means for pivotally connecting the members.

6. The firefighter tool of claim 1, wherein at least one of the force bearing surfaces comprises a planar surface.

7. The firefighter tool of claim 6, wherein at least one of the other force bearing surfaces comprises a planar surface.

8. A method for operating a rescue tool comprising: (a) providing a rescue tool comprising; a first member comprising a proximate end and a distal end, and a proximately disposed first handle and a distally disposed first jaw; a second member comprising a proximate end and a distal end, and a proximately disposed second handle and a distally disposed second jaw; means for pivotably connecting the members comprising a pivot axis, and being disposed between the handles and jaws so that the handles pivotably move the jaws from a first operable position to a second operable position; said jaws comprise surfaces adjacent the means for pivotably connecting the members; wherein said first operable position the jaws and handles are fully closed and in said second operable position the jaws and handles are fully opened; said jaws and handles having comprise contactingly engaged force bearing surfaces in contacting engagement in the second operable position only; said first handle comprises a wedge having an elongate edge, and said first handle further comprises a grip portion extending around the handle adjacent the wedge; said second handle comprises a hook disposed at the proximate end, said second handle further comprises an outwardly curved surface in facing disposition with the hook for operably engaging a coupling or a cap; and in the first operable mode; (b) gripping the tool adjacent the means for pivotably connecting the members in the first operable position and exerting a leverage force downwardly to effect an upward leverage force on the wedge edge; and (c1) gripping the tools in the first operable position and exerting a leverage force through the outwardly curved surface and hook to operably engage a coupling or cap, or, alternatively (c2) gripping the first handle grip portion in the second operable position and exerting a leverage force through the contactingly engaged force bearing surfaces to the outwardly curved surface and hook to exert a force on the coupling or cap.

9. The method of claim 8, wherein the angle is up to 114°.

10. The method of claim 8, wherein the second handle further comprises an inwardly curved surface disposed between the outwardly curved surface and the hook.

11. The method of claim 8, wherein the jaws comprise blade edges.

12. The method of claim 8, said first handle grip being disposed between the wedge and the means for pivotally connecting the members.

13. The method of claim 8, wherein at least one of force bearing surfaces comprises a planar surface.

14. The method of claim 13, wherein at least one other first force bearing surface comprises a planar surface.

15. The method of claim 8, wherein step (c1) or (c2) further comprises contactingly engaging the coupling or cap circumferential surface with a portion of the outwardly curved surface.

16. The method of claim 8, wherein the portion is immediately adjacent the most outwardly curved portion of the curved surface.

17. A method for operating a rescue tool comprising:
(a) providing a rescue tool to a user, said rescue tool comprises a first member comprising a proximate end and a distal end comprising a proximately disposed first handle and a distally disposed first jaw; a second member comprising a proximate end and a distal end comprising a proximately disposed second handle and a distally disposed second jaw; means for pivotably connecting the members comprising a pivot axis, and being disposed between the handles and jaws so that the handles pivotably move the jaws from a first operable position to a second operable position; said jaws comprise force bearing surfaces adjacent the means for pivotably connecting the members, wherein said first operable position the jaws and handles are fully closed and in said second operable position the jaws and handles are fully opened; said jaws force bearing surfaces are in contacting engagement in the second operable position only; said first handle comprises a wedge having an elongate edge; and said first handle further comprises a grip portion extending around the first handle adjacent the wedge; said second handle comprises a hook disposed at the proximate end, said second handle further comprises an outwardly curved surface in facing disposition with the hook for operably engaging a coupling or a cap; and
(b) said user using the tool of step (a) by (b1) gripping the tools in the first operable position and exerting a first torque force through the outwardly curved surface and hook to operably engage a rotatably seized fire hose connecting element having a cylindrical surface and a plurality of radially disposed lugs, or, alternatively (b2) gripping the first handle grip portion in the second operable position and exerting a leverage force through the contactingly engaged force bearing surfaces to the outwardly curved surface and hook to exert a second torque force on the rotatably seized fire hose connecting element.

18. The method of claim 17, wherein step (b) comprises a rescue operation, and the fire hose connecting element comprises a fire hose coupling or cap.

19. The method of claim 17, wherein step (b2) comprises opening the handles to the second operable position wherein the handles are disposed at up to 114°.

20. The firefighter tool of claim 17, wherein the second handle outwardly curved surface comprises a generally sinusoidal surface.

21. The firefighter tool of claim 17, further comprising (c) inserting the wedge in a seized window edge and exerting a leverage force to open the seized window.

22. The firefighter tool of claim 17, said first handle grip extends around the first handle for operably gripping the first handle.

23. The firefighter tool of claim 17, wherein at least one of the force bearing surfaces comprises a planar surface.

24. The firefighter tool of claim 23, wherein at least one other force bearing surface comprises a planar surface.

25. The method of claim 17, wherein step (a) further comprises providing the tool to a firefighter for operating the rescue tool in a rescue operation according to step (b).

26. The method of claim 17, wherein the second torque force is greater than the first torque force.

27. The method of claim 26, wherein step (b2) comprises opening the handles to the second operable position wherein the handles are disposed at up to 114°.

28. The method of claim 27, wherein the fire hose connecting element comprises a fire hose coupling or cap.

29. The method of claim 27, step (b1) and (b2) comprise contactingly engaging the fire hose connecting element cylindrical surface with the outwardly disposed surface.

30. The method of claim 29, wherein the outwardly disposed surface comprises a generally sinusoidal surface.
